(19) United States
(12) Patent Application Publication
(10) Pub. No.: US 2005/0232840 A1
(43) Pub. Date: Oct. 20, 2005

(54) Photocatalytic oxide for vehicle's side mirrors and producing method thereof

(76) Inventors: Chang Man Kim, Gyeonggi-do (KR); Hyok Joo Hwang, Gyeonggi-do (KR); Sun Kyoung Jeoung, Chungcheongnam-do (KR); Seong Jin Park, Chungcheongnam-do (KR); Seung Eul Yoo, Seoul (KR)

Correspondence Address: ST. ONGE STEWARD JOHNSTON & REENS, LLC, 986 BEDFORD STREET, STAMFORD, CT, 06905-5619, US

(21) Appl. No.: 10/963,288

(22) Filed: Oct. 12, 2004

(30) Foreign Application Priority Data
Apr. 16, 2004 (KR) 2004-26361

(51) Int. Cl. C01B 33/20

(52) U.S. Cl. 423/326; 423/598

(57) ABSTRACT

The present invention provides a photocatalytic oxide for car's side mirrors, which is coated on the chrome-coated layer of a front surface mirror to enhance the durability of the front surface mirror and to impart hydrophilicity to the front surface mirror, thus being capable of providing safe visibility for car drivers, as well as a producing method thereof. The producing method of the photocatalytic oxide comprises the steps of: stirring tetraethyl orthosilicate (TEOS) and titanium isopropoxide (TIP) in 2-propanol as a solvent, in which the volume ratio between the tetraethyl orthosilicate (TEOS) and the titanium isopropoxide (TIP) is 50:50, 30-50:40 or 20-40:30 while the amount of the solvent is maintained at a constant; subjecting the stirred mixture to a reaction; washing the reacted material with water/alcohol by centrifugation; separating the water/alcohol; and collecting a hydrophilic coating solution.

This application claims priority from pending Korean Patent Application No. 2004-26361 filed Apr. 16, 2004.

### FIELD OF THE INVENTION

The present invention relates to the field of photocatalytic oxides, and more particularly to a photocatalytic oxide for car's side mirrors, which is coated on the chrome-coated layer of a front surface mirror to enhance the durability of the front surface mirror and to impart hydrophilicity to the front surface mirror, thus being capable of providing superior visibility for car drivers, as well as a producing method thereof.

### DESCRIPTION OF THE PRIOR ART

In general, a car's side mirror is in a form where one surface of glass is coated with chrome. A mirror using a chrome-coated portion as a reflector refers to a front surface mirror, and a mirror using a chrome-uncoated portion as a reflector refers to a back surface mirror. Since the front surface mirror has a durability problem occurring in long-term use unlike the back surface mirror, the back surface mirror is mainly used.

On days with rain or high humidity, moisture formed on the car's side mirror is condensed to form water drops on the glass surface, and a light scattering phenomenon caused by such water drops makes the driver's visibility deteriorated, thus interfering with the safe operation of a car.

In an attempt to solve such a problem, technologies of forming a hydrophilic film on the surface of car's side mirrors are being developed.

Methods for forming a hydrophilic film, which have now been developed, include methods of coating the side mirror surface with polymer materials or surfactants to impart hydrophilicity to the side mirror surface.

However, these methods have a shortcoming in that the durability and abrasion resistance of the side mirror is not kept for long period.

For this reason, the development of a hydrophilic film using photocatalytic oxide is currently performed.

Currently known or proposed methods of forming a hydrophilic film using photocatalytic oxide include methods comprising coating an uncoated glass surface such as a back surface mirror with hydrophilic photocatalytic oxide (e.g., TiO₂, ZnO, Fe₂O₃, WO₃, and Al₂O₃), and then subjecting the coated film to light excitation, so that the coated film has a contact angle θ of less than 10° with the water drops, whereby one water film is formed on the coated film without forming water drops, such as moisture in air. Thus, the coated film shows hydrophilicity.

In the daytime, the photocatalytic oxide used in the prior methods of forming the hydrophilic film on the car's side mirror as described above shows hydrophilicity by sunlight (UV light) irradiation leading to the formation of many positive holes and electrons. However, at a time such as night, the photocatalytic oxide does not show hydrophilicity, since positive holes and electrons are slowly bound to each other to reduce their number, thus making the photocatalytic oxide hydrophobic.

### SUMMARY OF THE INVENTION

Accordingly, the present invention has been made to solve the above problems occurring in the prior art, and an object of the present invention is to provide a photocatalytic oxide for car's side mirrors, which is coated on the chrome-coated layer of a front surface mirror to enhance the durability of the front surface mirror and to impart hydrophilicity to the front surface mirror, thus being capable of providing superior visibility for car drivers, as well as a producing method thereof.

In order to accomplish the above object, in one aspect, the present invention provides a photocatalytic oxide containing tetraethyl orthosilicate (TEOS) and titanium isopropoxide (TIP) in a volume ratio of 50:50, 30-50:40, or 20-40:30.

In another aspect, the present invention provides a method for producing a photocatalytic oxide for car's side mirrors, the method comprising the steps of: stirring tetraethyl orthosilicate (TEOS) and titanium isopropoxide (TIP) in 2-propanol as a solvent, in which the volume ratio between the tetraethyl orthosilicate (TEOS) and the titanium isopropoxide (TIP) is 50:50, 30-50:40 or 20-40:30 while the amount of the solvent is maintained at a constant; subjecting the stirred mixture to a reaction; washing the reacted material with water/alcohol by centrifugation; separating the water/alcohol; and collecting a hydrophilic coating solution.

### BRIEF DESCRIPTION OF DRAWINGS

The above and other objects, features and advantages of the present invention will be more clearly understood from the following detailed description taken in conjunction with the accompanying drawings, in which:

FIG. 1 is a process flow chart showing a method of producing a photocatalytic oxide for a car's side mirrors according to an example of the present invention;

FIG. 2 is a process flow chart showing a method of coating a photocatalytic oxide for car's side mirrors according to an example of the present invention;

FIG. 3 shows the cross-sectional structure of a car's side mirror coated with a photocatalytic oxide according to an example of the present invention;

FIG. 4 shows the structure of an apparatus for measuring the initial contact angle and durability-in-dark of a car's side mirror coated with a photocatalytic oxide according to an example of the present invention; and

FIGS. 5 to 7 are graphic diagrams corresponding to Tables 1 to 3, respectively, which show the measurement results for the initial contact angle and durability-in-dark of a car's side mirror coated with a photocatalytic oxide according to an example of the present invention.

### DETAILED DESCRIPTION OF EMBODIMENTS

The present invention will now be described in further detail by way of the most preferred example with reference to the accompanying drawings, in order that the present invention can be easily practiced by a person skilled in the art.

It is to be understood that examples disclosed herein are only the most preferred examples selected from various practicable examples so as to enable those skilled in the art to understand, make and use the invention, and the technical concept of the invention is not limited by or to these examples. Those skilled in the art will appreciate that various modifications, additions and substitutions are possible, without departing from the technical concept of the invention.

In order to solve problems with the prior sol-gel or water-heat synthesis process, a hydrophilic photocatalytic oxide according to an example of the present invention is prepared by a solvent-heat synthesis process using only a basic catalyst and a pure solvent.

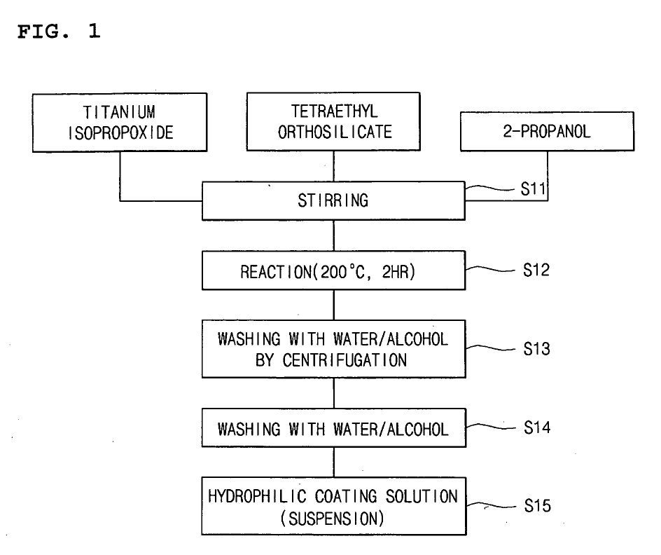

A method for producing a photocatalytic oxide according to an example of the present invention is shown in FIG. 1. As shown in FIG. 1, tetraethyl orthosilicate (TEOS, Si(OC₂H₅)₄) and titanium isopropoxide (TIP, Ti(O(CH₂CH₃)₄) are used as raw materials for the production of a photocatalytic oxide for a car's side mirrors according to an example of the present invention. As a solvent, 2-propanol is used.

First, tetraethyl orthosilicate (TEOS) and titanium isopropoxide (TIP) are stirred in 2-propanol as a solvent (S11). In this step, a hydrophilic material is prepared with varying amounts of tetraethyl orthosilicate (TEOS) and titanium isopropoxide (TIP) and a constant amount of the solvent.

In this step, in order to prevent a reduction in hydrophilic effect caused by oxide, such as CrTiO₄, which is produced if a chrome-coated layer, such as a front surface mirror, is coated with a photocatalytic oxide, tetraethyl orthosilicate (TEOS) is used at a larger amount than that of titanium isopropoxide (TIP).

The resulting hydrophilic material is subjected to reaction at about 200° C. for about 2 hours (S12), and then washed with water/alcohol by centrifugation (S13). Next, water/alcohol is separated from the washed material (S14), and a hydrophilic coating solution is collected (S15).

The photocatalytic oxide prepared as such is coated on a front surface mirror by a self-assembly monolayer process.

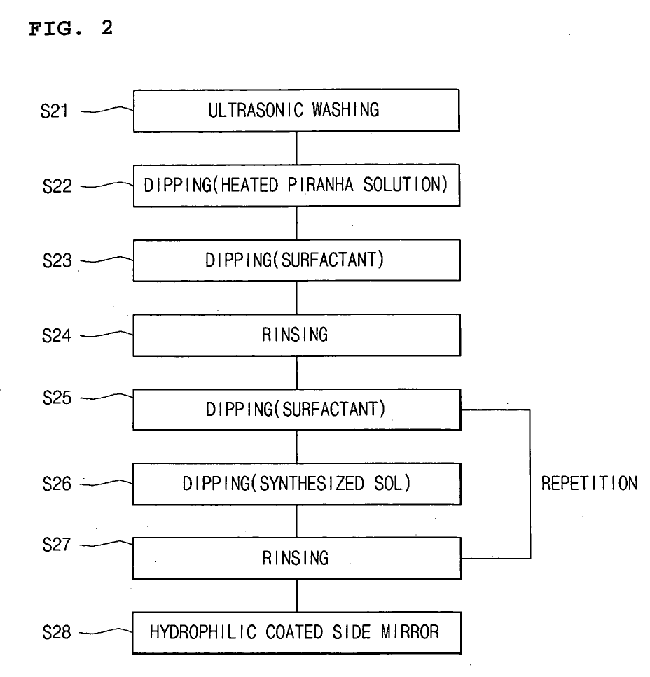

A method of coating a front side mirror with the photocatalytic oxide is shown in FIG. 2. As shown in FIG. 2, a front side mirror is washed by ultrasonic waves (S21), dipped in a heated cleaner solution (S22), dipped in a surfactant (S23), rinsed (S24), dipped in a surfactant (S25), dipped in the prepared photocatalytic oxide sol (S26), and then rinsed (S27). Next, the front side mirror coated with the hydrophilic photocatalytic oxide is collected (S28).

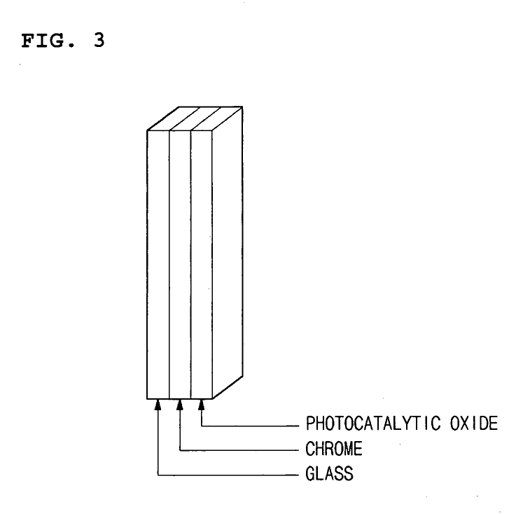

The cross-sectional structure of the car's side mirror coated with the photocatalytic oxide as described above is shown in FIG. 3.

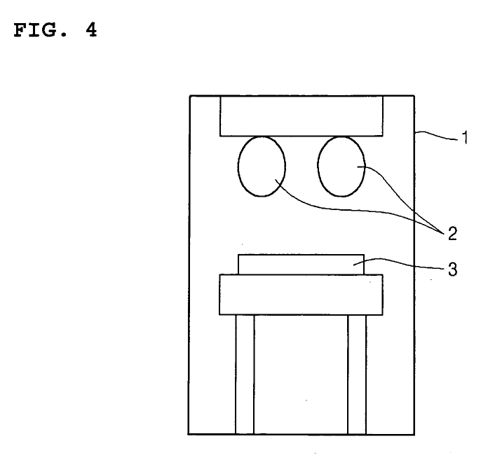

The contact angle and durability of the side mirror which had been coated with the hydrophilic photocatalytic oxide as described above are measured as shown in FIG. 4. These measurements are performed by irradiating a front surface mirror 3 with a UV lamp 3 in a dark room 1.

The measurement of the contact angle is performed by irradiating the side mirror 3 with the UV lamp (365 nm, 0.5 mW/cm²) in the dark room 1 for 24 hours, and then measuring contact angle with a contact angle measuring device (not shown). The measurement of durability-in-dark is performed by standing the side mirror 3 in the dark room 1 for 168 hours (7 days) without irradiation with the UV lamp 2, and then measuring contact angle with a contact angle measuring device (not shown).

The measurement results for the contact angle and durability-in-dark of the hydrophilic materials, which had been prepared with varying amounts of tetraethyl orthosilicate (TEOS) and titanium orthosilicate (TIP) and a constant amount of the solvent as described above, are given in Tables 1 to 3 below.

TABLE 1

| | TIP | TEOS | | Initial | |
|---|---|---|---|---|---|
| | amount | amount | Solvent | contact | Durability-in- |
| Sample | (volume | (volume | amount | angle (less | dark (less |
| No. | fraction) | fraction) | (volume) | than 10°) | than 30°) |
| 1 | 5 | 50 | 40 | 50 | 58 |
| 2 | 10 | 50 | 40 | 45 | 55 |
| 3 | 15 | 50 | 40 | 36 | 52 |
| 4 | 20 | 50 | 40 | 31 | 48 |
| 5 | 25 | 50 | 40 | 27 | 41 |
| 6 | 30 | 50 | 40 | 22 | 35 |
| 7 | 35 | 50 | 40 | 18 | 30 |
| 8 | 40 | 50 | 40 | 15 | 26 |
| 9 | 45 | 50 | 40 | 10 | 20 |
| 10 | 50 | 50 | 40 | 7 | 14 |

TABLE 2

| | TIP | TEOS | | Initial | |
|---|---|---|---|---|---|
| | amount | amount | Solvent | contact | Durability-in- |
| Sample | (volume | (volume | amount | angle (less | dark (less |
| No. | fraction) | fraction) | (volume) | than 10°) | than 30°) |
| 1 | 5 | 40 | 40 | 32 | 55 |
| 2 | 10 | 40 | 40 | 24 | 50 |
| 3 | 15 | 40 | 40 | 18 | 46 |
| 4 | 20 | 40 | 40 | 10 | 40 |
| 5 | 25 | 40 | 40 | 7 | 32 |
| 6 | 30 | 40 | 40 | 3 | 10 |
| 7 | 35 | 40 | 40 | 4 | 13 |
| 8 | 40 | 40 | 40 | 5 | 12 |
| 9 | 45 | 40 | 40 | 4 | 11 |
| 10 | 50 | 40 | 40 | 7 | 25 |

TABLE 3

| | TIP | TEOS | | Initial | |
|---|---|---|---|---|---|
| | amount | amount | Solvent | contact | Durability-in- |
| Sample | (volume | (volume | amount | angle (less | dark (less |
| No. | fraction) | fraction) | (volume) | than 10°) | than 30°) |
| 1 | 5 | 30 | 40 | 20 | 50 |
| 2 | 10 | 30 | 40 | 15 | 40 |
| 3 | 15 | 30 | 40 | 7 | 30 |
| 4 | 20 | 30 | 40 | 5 | 25 |
| 5 | 25 | 30 | 40 | 4 | 18 |
| 6 | 30 | 30 | 40 | 3 | 10 |
| 7 | 35 | 30 | 40 | 4 | 12 |
| 8 | 40 | 30 | 40 | 5 | 20 |
| 9 | 45 | 30 | 40 | 7 | 36 |
| 10 | 50 | 30 | 40 | 10 | 30 |

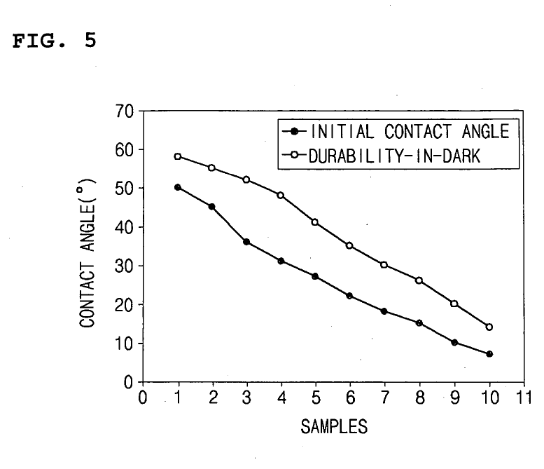

The measurement results given in Table 1 are shown as graphs in FIG. 5. As can be seen in Table 1 and FIG. 5, the sample containing tetraethyl orthosilicate (TEOS) and titanium isopropoxide (TIP) in a volume ratio of 50:50 shows an initial contact angle of less than 10° and a contact angle for the durability-in-dark of about 10°, indicating the best hydrophilic property.

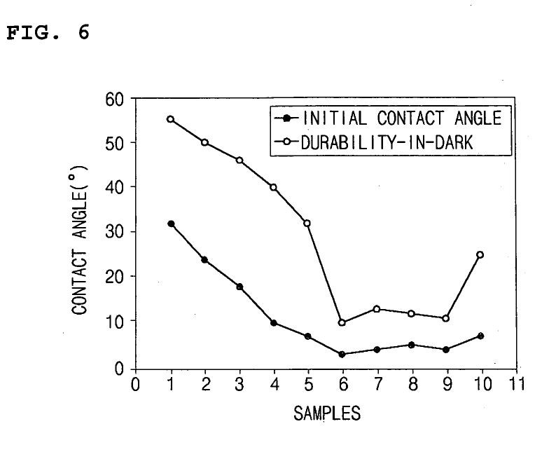

The measurement results given in Table 2 are shown as graphs in FIG. 6. As can be seen in Table 2 and FIG. 6, the samples containing tetraethyl orthosilicate (TEOS) and titanium isopropoxide (TIP) in volume ratios of 30-50:50, particularly the samples containing tetraethyl orthosilicate (TEOS) at a slightly larger amount than that of titanium isopropoxide (TIP), show an initial contact angle of 3° and a contact angle for durability-in-dark of 10°, indicating the best hydrophilic property. This is because the production of oxides such as CrTiO₄ occurring when coating the chrome-coated layer with the photocatalytic oxide is prevented by the use of an excess of tetraethyl orthosilicate (TEOS).

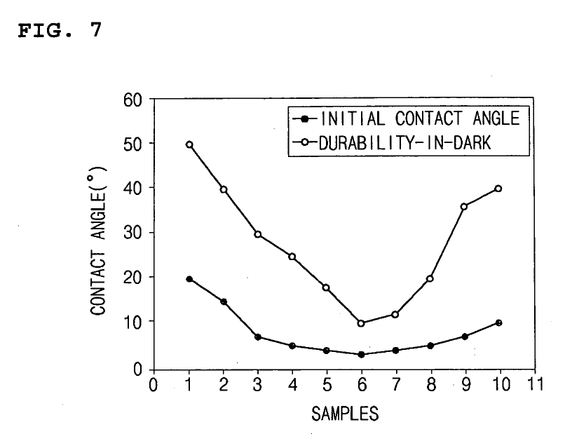

The measurement results given in Table 3 are shown as graphs in FIG. 7. As can be seen in Table 3 and FIG. 7, the samples containing tetraethyl orthosilicate (TEOS) and titanium isopropoxide (TIP) in volume ratios of 20-40:30, particularly the samples containing tetraethyl orthosilicate (TEOS) at a slightly larger amount than that of titanium isopropoxide (TIP), show an initial contact angle of 3° and a contact angle for the durability-in-dark of 10°, indicating the most excellent hydrophilic property.

With regard to the initial contact angle characteristic, hydrophobic molecules adsorbed on a coated film are finally decomposed into a substance, such as CO₂ or H₂O, by UV irradiation, while physically-adsorbed water binds to chemically-adsorbed water exposed to the surface of the coated film, thus rendering the coating film hydrophilic.

According to the present invention, the surface of a front surface mirror among car's side mirrors is coated with the hydrophilic material prepared by the solvent-heat synthesis process. Thus, the present invention has an effect capable of maximizing the use of the front surface mirror.

The hydrophilic material according to the present invention is prepared by the method overcoming problems with the prior water-heat synthesis or sol-gel process, and coated on a side mirror by the self-assembly monolayer process. Thus, the inventive hydrophilic material results in superior uniformity and adhesion of the side mirror, thus making the durability and hydrophilicity of the side mirror superior. Accordingly, the hydrophilic material shows hydrophilicity even after standing for 168 hours (7 days) in a dark place, suggesting that it provides superior visibility for drivers, even at night or in rainy weather.

As described above, the present invention provides the photocatalytic oxide, which is coated on the chrome-coated layer of a front surface mirror to enhance the durability of the front surface mirror and to impart hydrophilicity to the front surface mirror, thus being capable of providing safe visibility for car drivers.

1. A photocatalytic oxide for car's side mirrors, which contains tetraethyl orthosilicate (TEOS) and titanium isopropoxide (TIP) in a volume ratio of 50:50, 30-50:40, or 20-40:30.

2. The photocatalytic oxide as set forth in clamin 1, the photocatalytic oxide is coated on a front surface mirror for cars.

3. A method for preparing a photocatalytic oxide for car's side mirrors, the method comprising the steps of:
stirring tetraethyl orthosilicate (TEOS) and titanium isopropoxide (TIP) in 2-propanol as a solvent, in which the volume ratio between the tetraethyl orthosilicate (TEOS) and the titanium isopropoxide (TIP) is 50:50, 30-50:40 or 20-40:30 while the amount of the solvent is maintained at a constant;
subjecting the stirred mixture to a reaction;
washing the reacted material with water/alcohol by centrifugation;
separating the water/alcohol; and
collecting a hydrophilic coating solution.
